(19) United States
(12) Patent Application Publication
(10) Pub. No.: US 2005/0209926 A1
(43) Pub. Date: Sep. 22, 2005

(54) Email World Lottery

(75) Inventor: Scot Dale Hartman, Sherman Oaks, CA (US)

Correspondence Address: Scot Dale Hartman, 13215 Moorpark Street #3, Sherman Oaks, CA, 91423, US

(73) Assignee: Scot Dale Hartman, Sherman Oaks, CA (US)

(21) Appl. No.: 10/708,695

(22) Filed: Mar. 18, 2004

(51) Int. Cl. G06F 17/60; G06F 15/16

(52) U.S. Cl. 705/26; 705/14; 705/37

(57) ABSTRACT

Email World Lottery is an internet based lottery system where winning contestants are notified by email. This lottery is open to the World. Drawings are held every week on Friday at 3:00 pm Eastern Standard Time. There are two Tickets to choose from; World Million and World Maximum. The World Million Ticket costs one dollar and is limited to One purchase per Email Address. The World Million Ticket cost one dollar and the user can purchase an unlimited amount of tickets.

### DETAILED DESCRIPTION

Email World Lottery is an internet based lottery system where winning contestants are notified by email. This lottery is open to the World. Drawings are held every week on Friday at 3:00 pm Eastern Standard Time. There are two Tickets to choose from; World Million and World Maximum. The World Million Ticket costs one dollar and is limited to One purchase per Email Address. The World Million Ticket cost one dollar and the user can purchase an unlimited amount of tickets.

A user will open up the Email World Lottery Homepage at www.emailworldlottery.com. Here, the user will be asked to select a ticket and to provide their username and password. If the user Does Not have a user id and password, he/she will be asked to create one. The new user will be redirected to a secure page where they can provide their email address, name, street address, city, state, and telephone number. They will then be asked to check their email for their new user id and password to Email World Lottery. The email will include their new user id, password and hyperlink back to Email World Lottery. At this point the user is a registered user at Email World Lottery.

Registered users will be asked to select the ticket(s), the quantity, and provide their user id and password. The quantity for the World Million ticket Cannot exceed One purchase per email address. The Quantity for the World Maximum is unlimited. Users can select both tickets. If the World Million Ticket reaches its limit of 1 million tickets the field is no longer available. There are indicators next to each ticket that show the amount of the jackpot for each draw.

Once the user has provided their ticket purchase information, they will enter their user id and password and click the submit button. Upon submitting their information the user will be transferred to a secure page that will include: the quantity of tickets they purchased, the cost, their personal information, payment type, payment information, legal agreement, and other Email World Lottery promotions.

After reviewing their personal information, completing the payment section, and accepting the legal agreement, the user will be notified that their Email World Lottery confirmation number and receipt has been sent to their email address. The email will include the previously mentioned information and the time of the drawing.

The Email World Lottery system will query the database on Friday at 2:51 pm Eastern Standard time. It will select one email address from the participating contestants in the World Million database and one email address from the World Maximum database. Once the winning email addresses have been established, the winning contestant(s) will receive an email stating they Won and that a representative from Email World Lottery will be in touch with them shortly. There is a winner every week and One contestant can win both tickets.

1. What I claim as my invention is a process for people around the world to submit their e-mail address as their registered ticket entry into an internet-based lottery system website for a fee, said process consisting essentially of a website with a structured sequence that provides the option to purchase the “World Million” and “World Maximum” selections, and includes: data boxes that show the two jackpot amounts, an area to enter a contestant user ID and password, a detailed information page (for purchasing information, personal data, legal agreement, and submission), a confirmation page that shows the contestants receipt and states that their confirmation number/receipt has been sent to their e-mail address, and a program that will query the email database every week on Friday at 2:51 p.m. Eastern Standard Time, then determine One winning e-mail address per jackpot every week within the definitions of the “World Million” (limited to one million entries and one entry per e-mail address) and the “World Maximum” (unlimited entries and purchases) jackpots, with notification via e-mail to the winning contestants, every Friday at 3 p.m. Eastern Standard Time.
